(19) United States
(12) Patent Application Publication
(10) Pub. No.: US 2018/0027292 A1
(43) Pub. Date: Jan. 25, 2018

(54) SYSTEMS AND METHODS FOR RESOLVING RECORDING CONFLICTS

(71) Applicant: NAGRAVISION S.A., Cheseaux-sur-Lausanne (CH)

(72) Inventor: Jayne GILMOUR, Cwmbran (GB)

(21) Appl. No.: 15/549,790

(22) PCT Filed: Feb. 11, 2016
(86) PCT No.: PCT/EP2016/052947

§ 371 Date: Aug. 9, 2017

(30) Foreign Application Priority Data
Feb. 12, 2015 (GB) 1502357.5

(51) Int. Cl. H04N 21/458; H04N 21/431

(52) U.S. Cl. CPC H04N 21/4583; H04N 21/4312

(57) ABSTRACT

A device for enabling a user to resolve recording conflicts is configured to display an interactive graphical user interface illustrating programming associated with recording conflicts. The graphical user interfaces enables a user to select programming associated with a recording conflict. A user may cancel a scheduled recording of a selected programming either partially or completely.

### FIELD OF THE INVENTION

The present disclosure relates to the field of interactive scheduled transmitted event recording.

### BACKGROUND OF THE INVENTION

Digital media playback capabilities may be incorporated into a wide range of devices, including digital televisions, so-called “smart” televisions, laptop or desktop computers, tablet computers, e-book readers, personal digital assistants (PDAs), digital recording devices, digital media players, video gaming devices, digital cameras, cellular telephones, including so-called “smart” phones, dedicated video streaming devices, and the like. Digital media content may originate from multiple sources including, for example, over-the-air television providers, satellite television providers, and cable television providers. In order to access digital media content from one of these sources, a device may include a tuner to physically tune to a frequency band and a de-multiplexor to extract digital content from within the frequency band. For example, a set-top box may include a DVB or an ASTC tuner.

A recording device such as a personal video recorder (PVR) or a digital video recorder (DVR) may be operably coupled to or integrated into a device including tuners and/or decoders. The recording device may be configured to store media content accessed through a tuner or decoder. This may enable a user to watch a scheduled event such as television programming at a later point in time (i.e., “time-shift” to a television show). Currently, the number of channels provided by way of service offerings that can be recorded at a point in time is limited based on the number of tuners or decoders. For example, a basic set-top box having recording capabilities may include two tuners. In this case, two programs may be recorded simultaneously or one program may be watched while another program is being recorded. In another example, a set-top box may include more than two tuners (e.g., 3-6). In a typical example where a set-top box includes five tuners, five programs may be recorded simultaneously or a program may be watched while four other programs are being recorded. It should be noted that in some cases the number of simultaneous recordings may be greater than the number of tuners. For example, if a digital video recorder is configured to de-multiplex and record multiple programs from a tuned channel (e.g., record four digital channels from a single RF channel).

When a user attempts to watch or record a scheduled event when no tuners or decoders are available, a conflict occurs. For example, a user may attempt to schedule a recording, but each tuner may already be scheduled to tune to other service offerings during this time. Currently, devices may display an indication of the presence of a conflict.

### SUMMARY OF THE INVENTION

Conventional displays of information indicating the presence of recording conflicts do nothing but highlight the problem. None of the information useful to resolving the conflict, and no means of effecting a suitable solution resolution are provided.

The example system and techniques described herein may enable a user of a device having recording capabilities to more efficiently resolve recording conflicts through one or more interactive graphical user interfaces that provide clear visual indications of conflicts between scheduled events and enable a resolution.

The following brief summary is not intended to include all features and aspects of the present invention, nor does it imply that the invention must include all features and aspects discussed in this summary. The techniques may be implemented in a device with digital media playback capabilities, including for example, laptop or desktop computers, tablet computers, smart phones, set top boxes, and televisions.

According to one example of the disclosure, a method for enabling a user of a device having recording capabilities to resolve recording conflicts comprises presenting an interactive graphical user interface including a listing, wherein the listing includes one or more service offerings including previously scheduled recordings and a service offering including a potential scheduled recording, wherein the potential scheduled recording causes a recording conflict, enabling a user to select an event associated with the recording conflict presented in the interactive graphical user interface, and enabling a user to change a recording status of the selected event associated with the recording conflict.

According to another example, a device having recording capabilities comprises one or more processors configured to present an interactive graphical user interface including a listing, wherein the listing includes one or more service offerings including previously scheduled recordings and a service offering including a potential scheduled recording, wherein the potential scheduled recording causes a recording conflict, enable a user to select an event associated with the recording conflict presented in the interactive graphical user interface, and enable a user to change a recording status of the selected event associated with the recording conflict.

According to another example, an apparatus for enabling a user of a device having recording capabilities to resolve recording conflicts comprises means for presenting an interactive graphical user interface including a channel listing, wherein the channel listing includes one or more channels including previously scheduled recordings and a channel including a potential scheduled recording, wherein the potential scheduled recording causes a recording conflict, means for enabling a user to select programming associated with the recording conflict, and means for enabling a user to change a recording status of selected programming associated with the recording conflict.

According to another example, a non-transitory computer-readable storage medium has instructions stored thereon that upon execution cause one or more processors of a device to present an interactive graphical user interface including a channel listing, wherein the channel listing includes one or more channels including previously scheduled recordings and a channel including a potential scheduled recording, wherein the potential scheduled recording causes a recording conflict presented in the interactive graphical user interface, enable a user to select programming associated with the recording conflict, and enable a user to change a recording status of selected programming associated with the recording conflict.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is block diagram illustrating an example of a system that may implement one or more techniques of this disclosure;

FIG. 2 is a block diagram illustrating an example of a computing device that may implement one or more techniques of this disclosure;

FIG. 3 illustrates an example of an input/output device that may implement one or more techniques of this disclosure;

FIGS. 4A-4E illustrate an example of graphical user interfaces in accordance with one or more techniques of this disclosure;

FIG. 5 illustrates an example of a graphical user interface in accordance with one or more techniques of this disclosure; and

FIG. 6 is illustrates a further example of a graphical user interface in accordance with one or more techniques disclosed.

### DETAILED DESCRIPTION OF THE INVENTION

Described herein are systems and methods for enabling a user of a device having recording capabilities to more efficiently resolve recording conflicts. Some embodiments extend to a machine-readable medium embodying instructions which, when executed by a machine, cause the machine to perform any one or more of the methodologies described herein. Other features will be apparent from the accompanying drawings and from the detailed description that follows. Examples merely typify possible variations. Unless explicitly stated otherwise, components and functions are optional and may be combined or subdivided, and operations may vary in sequence or may be combined or subdivided. In the following description, for purposes of explanation, numerous specific details are set forth to provide a thorough understanding of example embodiments. It will be evident to one skilled in the art, however, that the present subject matter may be practiced without these specific details.

The techniques described herein may enable a user of a device having recording capabilities to more efficiently resolve recording conflicts by providing one or more interactive graphical user interfaces. The example graphical user interfaces described herein may be configured to provide a user with clear visual indications of a recording conflict and the means for resolving it. Further, the example graphical user interfaces described herein may be configured to provide a user with clear visual indications of one or more options and for taking action to resolve a recording conflict.

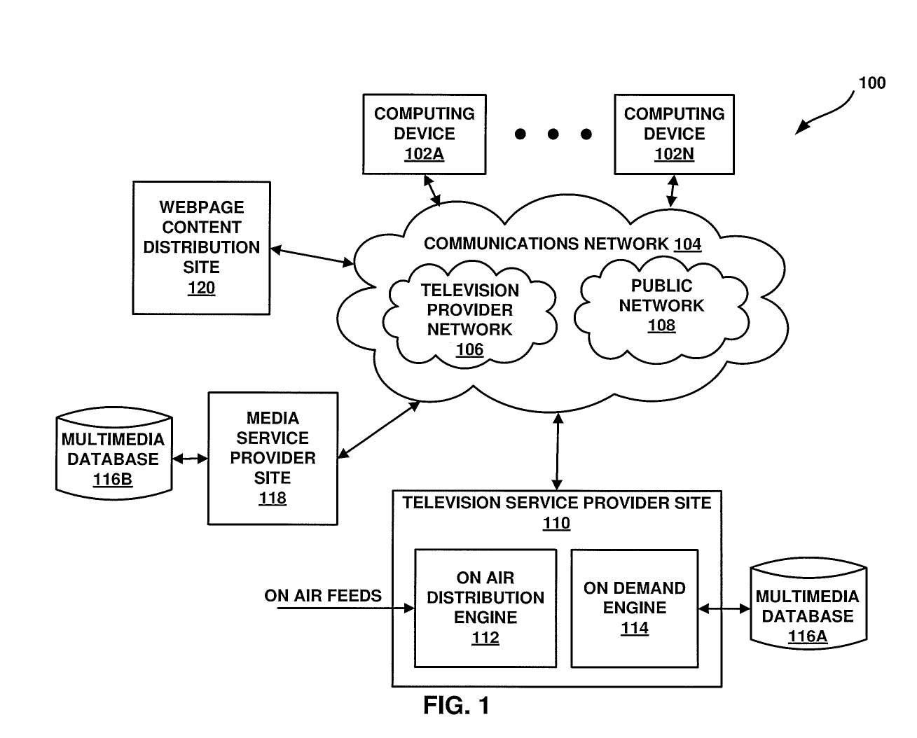

FIG. 1 is block diagram illustrating an example of a system that may implement one or more techniques described in this disclosure. System 100 may be configured to enable resolution of recording conflicts in accordance with the techniques described herein. In the example illustrated in FIG. 1, system 100 includes one or more computing devices 102A-102N, communications network 104, television service provider site 110, media service provider site 118, and webpage content distribution site 120. System 100 may include software modules operating on one or more servers. Software modules may be stored in a memory and executed by a processor. Servers may include one or more processors and a plurality of internal and/or external memory devices. Examples of memory devices include file servers, FTP servers, network attached storage (NAS) devices, local disk drives, or any other type of device or storage medium capable of storing data. Storage medium may include Blu-ray discs, DVDs, CD-ROMs, flash memory, the Cloud or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow digital content, such as, for example, music, videos, images, webpages, messages, voice communications, and applications, to be distributed to and accessed by a plurality of computing devices, such as computing devices 102A-102N. In the example illustrated in FIG. 1, computing devices 102A-102N may include any device configured to transmit data to and/or receive data from communication network 104. For example, computing devices 102A-102N may be equipped for wired and/or wireless communications and may include set top boxes, digital video recorders, televisions, desktop, laptop, or tablet computers, gaming consoles, mobile devices, including, for example, “smart” phones, cellular telephones, and personal gaming devices. It should be noted that although example system 100 is illustrated as having distinct sites, such an illustration is for descriptive purposes and does not limit system 100 to a particular physical architecture. Functions of system 100 and sites included therein may be realized using any combination of hardware, firmware and/or software implementations.

Communications network 104 may comprise any combination of wireless and/or wired communication media. Communications network 104 may include coaxial cables, fiber optic cables, twisted pair cables, wireless transmitters and receivers, routers, switches, repeaters, base stations, or any other equipment that may be useful to facilitate communications between various devices and sites. Communications network 104 may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the 802 standards.

As illustrated in FIG. 1, networks of different types may be defined within communications network 104. Networks may be defined according to physical and/or logical aspects. For example, networks that share the same physical infrastructure (e.g., coaxial cables) may be distinguished based on a primary service type (e.g., webpage access or television service). Physical and logical aspects of networks may be described according to a layered model. For example, layers of a model may respectively define physical signaling, addressing, channel access control, packet properties, and data processing in a communications system. One example of a layered model is the Open Systems Interconnection (OSI) model. In the example illustrated in FIG. 1, communications network 104 includes television provider network 106 and public network 108. It should be noted that although television provider network 106 and public network 108 are illustrated as distinct, television provider network 106 and public network 108 may share physical and/or logical aspects.

Television provider network 106 is an example of a network configured to provide a user with television services. For example, television provider network 106 may include public over-the-air television networks, public or subscription-based satellite television service provider networks, and public or subscription-based cable television provider networks. It should be noted that although in some examples television provider network 106 may primarily be used to provide television services, television provider network 106 may also provide other types of data and services according to any combination of the telecommunication protocols described herein. Public network 108 is an example of a packet-based network, such as, a local area network, a wide-area network, or a global network, such as the Internet, configured to provide a user with World Wide Web based services. Public network 108 may be configured to operate according to Internet Protocol (IP) standards. It should be noted that although in some examples public network 108 may primarily be used to provide access to hypertext web pages, public network 108 may also provide other types of media content according to any combination of the telecommunication protocol described herein.

Referring again to FIG. 1, television service provider 110 represents an example of a television service provider site. Television service provider 110 may be configured to provide computing devices 102A-102N with television service. For example, television service provider 110 may be a public broadcast station, a cable television provider, or a satellite television provider and may be configured to provide television services to analog and/or digital televisions and set top boxes. In the example illustrated in FIG. 1, television service provider 110 includes on air distribution engine 112 and on demand engine 114. On air distribution engine 112 may be configured to receive a plurality of on air feeds and distribute the feeds to computing devices 102A-102N through television provider network 106. For example, on air distribution engine 112 may be configured to receive one or more over-the-air television broadcasts via a satellite uplink/downlink and distribute the over-the-air television broadcasts to one or more users of a subscription-based cable television service. As described above, a device, for example computing devices 102A-102N may be configured to record content originating from a television service provider site.

On demand engine 114 may be configured to access a multimedia library and distribute multimedia content to one or more of computing devices 102A-102N through television provider network 106. For example, on demand engine 114 may access multimedia content (e.g., music, movies, and TV shows) stored in multimedia database 116A and provide a subscriber of a cable television service with movies on a Pay Per View (PPV) basis. Multimedia database 116A may be a storage device configured to store multimedia content. It should be noted that multimedia content accessed through on demand engine 114 may also be located at various sites within system 100 (e.g., peer-to-peer distribution).

Media service provider site 118 represents an example of a multimedia service provider. Media service provider site 118 may be configured to access a multimedia library and distribute multimedia content to one or more of computing devices 102A-102N through public network 108. For example, media service provider site 118 may access multimedia (e.g., music, movies, and TV shows) stored in multimedia database 116B and provide a user of a media service with multimedia. In some examples, multimedia may include live events (e.g., sporting events) and/or currently airing television programs. Multimedia database 116B may be a storage device configured to store multimedia content. In one example, media service provider site 118 may be configured to provide content to one or more of computing devices 102A-102N using the Internet protocol suite. In some examples, a media service may be referred to as a streaming service. As described above, television provider network 106 and public network 108 may share physical and logical aspects. Thus, content accessed by one or more of computing devices 102A-102N through media service provider site 118 may be transmitted through physical components of television provider network 106. For example, a user of a computing device may access the internet and multimedia content provided by a media service may be provided to a user through a cable modem connected to a coaxial network maintained by a cable television provider.

Webpage content distribution site 120 represents an example of a webpage service provider. Webpage content distribution site 120 may be configured to provide hypertext based content to one or more of computing devices 102A-102N through public network 108. It should be noted that hypertext based content may include audio and video content. Hypertext content may be defined according to programming languages, such as, for example, Hypertext Markup Language (HTML), Dynamic HTML, and Extensible Markup Language (XML). Examples of webpage content distribution sites include the Wikipedia website and the European Patent Office website. It should be noted that in some examples, the graphical user interfaces described herein may be implemented using a webpage content distribution site. For example, system 100 may be configured such that a user may schedule a recording on a recording device located in the user's home remotely using a secondary device, e.g., a smart phone. In this example, the graphical user interfaces described herein may be presented to a user on the secondary device through a web browser or a dedicated application.

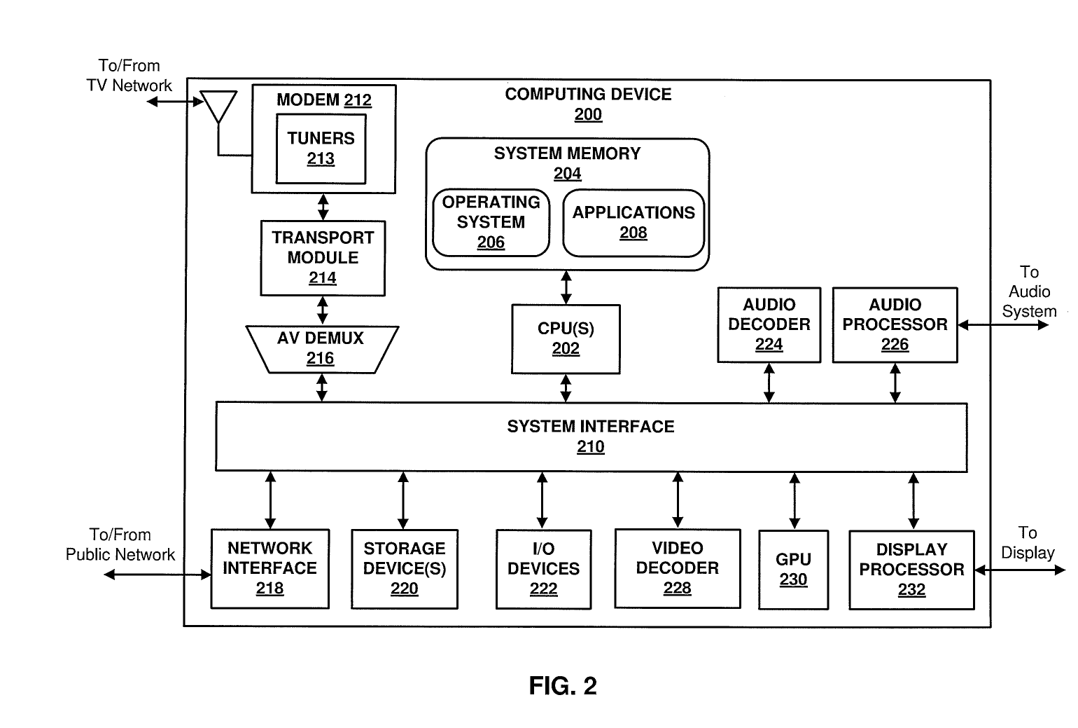

FIG. 2 is a block diagram illustrating an example of a computing device that may implement one or more techniques of this disclosure. Computing device 200 is an example of a computing device that may be configured to transmit data to and receive data from a communications network, allow a user to access multimedia content, and execute one or more applications. Computing device 200 may include or be part of a stationary computing device (e.g., a desktop computer, a television, a set-top box, a gaming console, a dedicated multimedia streaming device, or a digital video recorder), a portable computing device (e.g., a mobile phone, a laptop, a personal data assistant (PDA), or a tablet device) or another type of computing device. In the example illustrated in FIG. 2, computing device 200 is configured to send and receive data via a television network, such as, for example, television network 106 described above and send and receive data via a public network, such as, for example, public network 108. Further, computing device 200 is configured to record multimedia content received through one or more tuners. The techniques described herein may be utilized by devices configured to communicate using any and all combinations of communications networks.

As illustrated in FIG. 2, computing device 200 includes central processing unit(s) 202, system memory 204, system interface 210, modem 212, tuners 213, transport module 214, AV demux 216, network interface 218, storage devices 220, I/O devices 222, audio decoder 224, audio processor 226, video decoder 228, graphics processing unit 230, and display processor 232. As illustrated in FIG. 2, system memory 204 includes operating system 206 and applications 208. Each of processor(s) 202, system memory 204, system interface 210, modem 212, tuners 213, transport module 214, AV demux 216, network interface 218, storage devices 220, I/O devices 222, audio decoder 224, audio processor 226, video decoder 228, graphics processing unit 230, and display processor 232 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

CPU(s) 202 may be configured to implement functionality and/or process instructions for execution in computing device 200. CPU(s) 202 may be capable of retrieving and processing instructions, code, and/or data structures for implementing one or more of the techniques described herein. Instructions may be stored on a computer readable medium, such as system memory 204 or storage devices 220. CPU(s) 202 may include multi-core central processing units.

System memory 204 may be described as a non-transitory or tangible computer-readable storage medium. In some examples, system memory 204 may provide temporary and/or long-term storage. In some examples, system memory 204 or portions thereof may be described as non-volatile memory and in other examples portions of system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories.

System memory 204, may be configured to store information that may be used by computing device 200 during operation. System memory 204 may be used to store program instructions for execution by CPU(s) 202 and may be used by software or applications running on computing device 200 to temporarily store information during program execution. For example, system memory 204 may store instructions associated with operating system 206 and applications 208. Applications 208 may include applications implemented within or executed by computing device 200 and may be implemented or contained within, operable by, executed by, and/or be operatively/communicatively coupled to components of computing device 200. Applications 208 may include instructions that may cause CPU(s) 202 of computing device 200 to perform particular functions. Applications 208 may include algorithms which are expressed in computer programming statements, such as, for-loops, while-loops, if-statements, do-loops, etc. Applications 208 may be configured to enable a user to record multimedia content originating from a network.

As further illustrated in FIG. 2, applications 208 may execute in conjunction with operating system 206. That is, operating system 206 may be configured to facilitate the interaction of applications 208 with CPU(s) 202, and other hardware components of computing device 200. It should be noted that in some examples, components of operating system 206 and components acting in conjunction with operating system 206 may be referred to as middleware. The techniques described herein may be utilized by devices configured to operate using any and all combinations of software architectures. Operating system 206 may be an operating system designed to be installed on laptops, desktops, smartphones, tablets, set-top boxes, digital video recorders, televisions and/or gaming devices. In one example, operating system 206 may include one or more of operating systems or middleware components developed by OpenTV, Windows operating systems, Linux operation systems, Mac operating systems, Android operating systems, and any and all combinations thereof

System interface 210, may be configured to enable communications between components of computing device 200. In one example, system interface 210 comprises structures that enable data to be transferred from one peer device to another peer device or to a storage medium. For example, system interface 210 may include a chipset supporting Accelerated Graphics Port (“AGP”) based protocols, Peripheral Component Interconnect (PCI) bus based protocols, such as, for example, the PCI Express™ (“PCIe”) bus specification, which is maintained by the Peripheral Component Interconnect Special Interest Group, or any other form of structure that may be used to interconnect peer devices.

Storage devices 220 represent memory of computing device 200 that may be configured to store relatively larger amounts of information for relatively longer periods of time than system memory 204. For example, storage devices 220 may be configured to store hours of recorded video programming or other received content. Similar to system memory 204, storage device(s) 220 may also include one or more non-transitory or tangible computer-readable storage media. Storage device(s) 220 may include internal and/or external memory devices and in some examples may include volatile and non-volatile storage elements.

I/O devices 222 may be configured to receive input and provide output during operation of computing device 200. Input may be generated from an input device, such as, for example, a push-button remote control, a motion based remote control, a device including a touch-sensitive screen, a device including a track pad, a mouse, a keyboard, a microphone, a video camera, a motion sensor, or any other type of device configured to receive user input. In one example, an input device may include an advanced user input device, such as a smart phone or a tablet computing device. For example, an input device may be a secondary computing device and may be configured to receive user input via touch gestures, buttons on the secondary computing device, and/or voice control. Further, in some examples, an input device may include a display that is configured to display the graphical users interfaces described herein. For example, in the example where computing device 200 includes a television, an input device may include a smart phone in communication with the television. In this example, a user may provide commands to a television by activating portions of a graphical user interface displayed on a smart phone. Output may be provided to output devices, such as, for example internal speakers, an integrated display device, and/or external components, such as, a secondary computing device. In some examples, I/O device(s) 222 may be operatively coupled to computing device 200 using a standardized communication protocol, such as for example, Universal Serial Bus protocol (USB), Bluetooth, ZigBee or a proprietary communications protocol, such as, for example, a proprietary infrared communications protocol.

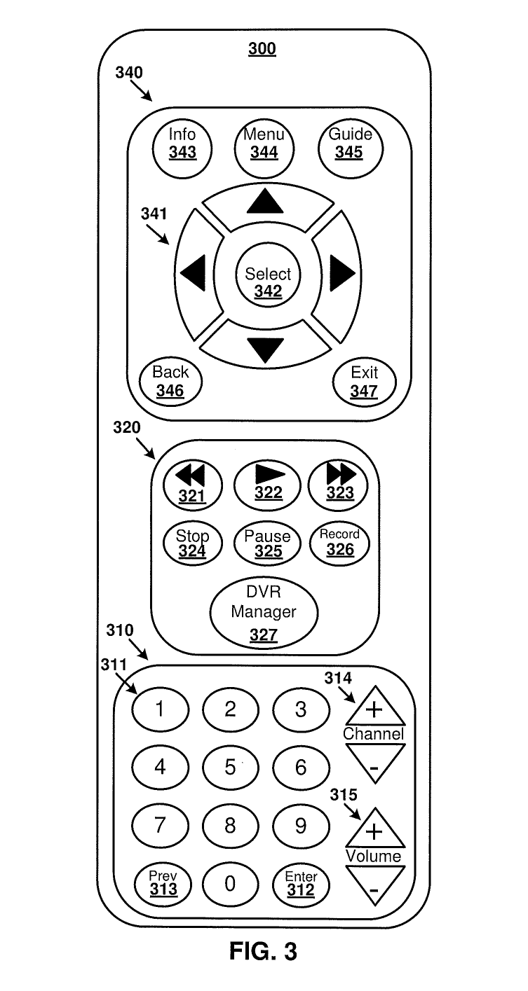

FIG. 3 is a conceptual diagram illustrating an example of an input/output (I/O) device 300 that may implement one or more techniques of this disclosure. In the example illustrated in FIG. 3, I/O device 300 is illustrated as a push-button remote control which, in this embodiment, communicates with the device it controls by an infrared digitally encoded transmission from the remote control and received by the controlled device. Other means of communication are equally applicable, such as by WiFi, Bluetooth, wired or optical connection. Alternatively, the functions of the remote control can be carried out directly on the device itself by way, for example, of local push buttons or a touch screen. It should also be noted that while I/O device 300 is illustrated as a push-button remote control in the example illustrated in FIG. 3, in other examples, the functionality of I/O device 300 may be implemented using other I/O devices, such as, for example, a secondary computing device in communication with a primary computing device. Further, in other examples, functions achieved by activation of buttons of I/O device 300 may be achieved through other types of user inputs. For example, in the example where an I/O device includes a touchscreen, gesture recognition, and/or voice recognition, virtual buttons may be presented on the touchscreen and functions achieved by activation of buttons on I/O device 300 may be achieved through any and all combinations of virtual button activation, motion gestures, and/or voice commands. In one example, an I/O device may have voice recognition capabilities and a function achieved by activation of DVR manager button 327 may be achieved by a user saying “My DVR” or a similar phrase.

In the example illustrated in FIG. 3, I/O device 300 includes basic television controls 310, playback/recording controls 320, and navigational controls 340. Basic television controls 310 may be configured to enable a user to perform basic tuning and volume control functions associated with viewing television programming. As illustrated in FIG. 3, basic television controls 310 include numeric keypad 311, enter button 312, previous channel button 313, channel change buttons 314, and volume control buttons 315. Numeric keypad 311, enter button 312, previous channel button 313, and channel buttons 314 may be configured to enable a user to tune to a particular analog and/or digital channel. Upon a user entering a sequence of numbers using numeric keypad 311 and, optionally, additionally activating enter key 312, a tuner may tune to a specified channel. Upon activation of previous channel button 313, a tuner may tune to a previously tuned channel. Activation of “+” and “−” channel buttons 314 may respectively cause a tuner to tune to the respective next channel in a sequence of channels. Activation of “+” and “−” volume control buttons 315 may respectively cause the output of an audio system to be increased or decreased. It should be noted that although the basic television controls 310 may be configured to enable a user to perform basic tuning and volume control functions associated with a television, in some examples, basic television controls 312 may be used to perform other functions associated with a computing device.

Playback/Recording controls 320 may be configured to enable a user to control the playback of and/or record multimedia content. For example, playback/recording controls 320 may enable a user to control the playback of a video originating from a media service provider site, an on demand engine, and/or a digital video recorder (DVR). As illustrated in FIG. 3, playback/recording controls 320 include reverse playback button 321, normal playback button 322, forward playback button 323, stop playback button 324, pause playback button 325, record button 326, and DVR manager button 327. Reverse playback button 321 may enable a user to navigate to a previous point in a multimedia sequence. Upon activation, normal playback button 322 may cause normal playback of an item of multimedia content to begin or resume. Forward playback button 323 may enable a user to navigate to a future point in a multimedia sequence. Upon activation, stop playback button 324 may cause the playback of an item of multimedia content to cease. Upon activation, pause playback button 325 may cause the playback of an item of multimedia content to be paused.

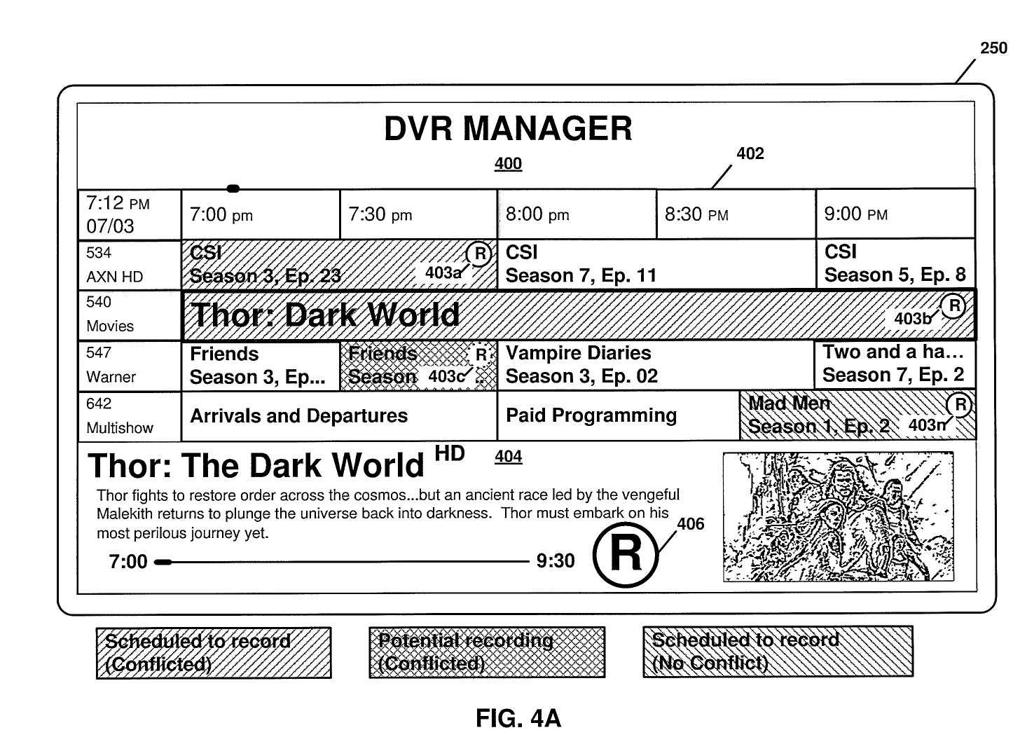

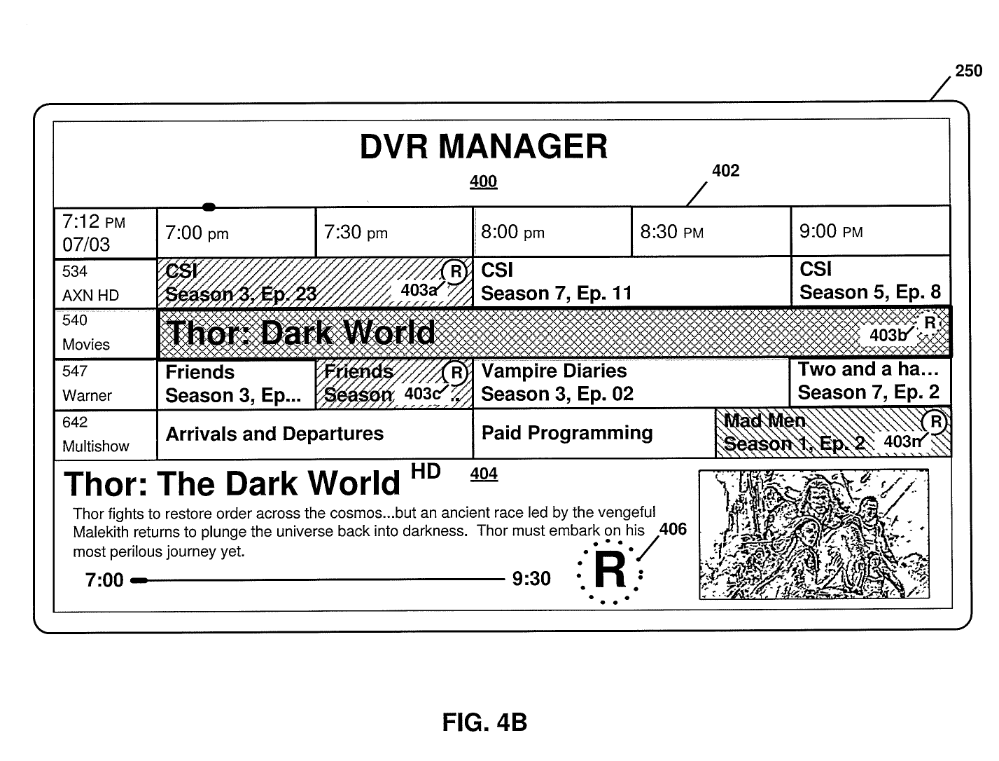

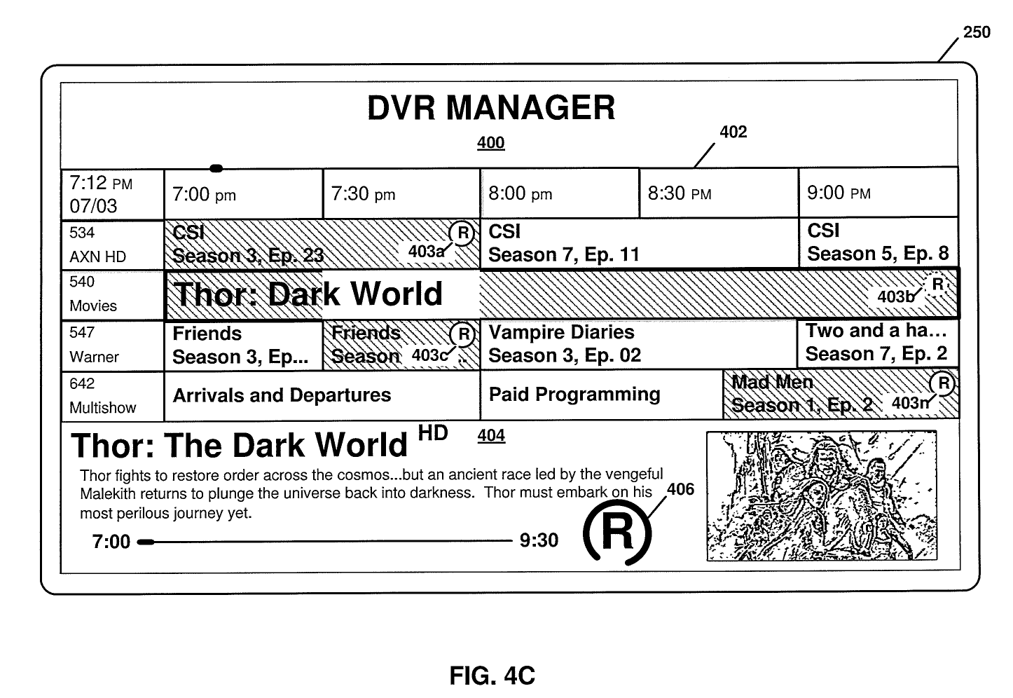

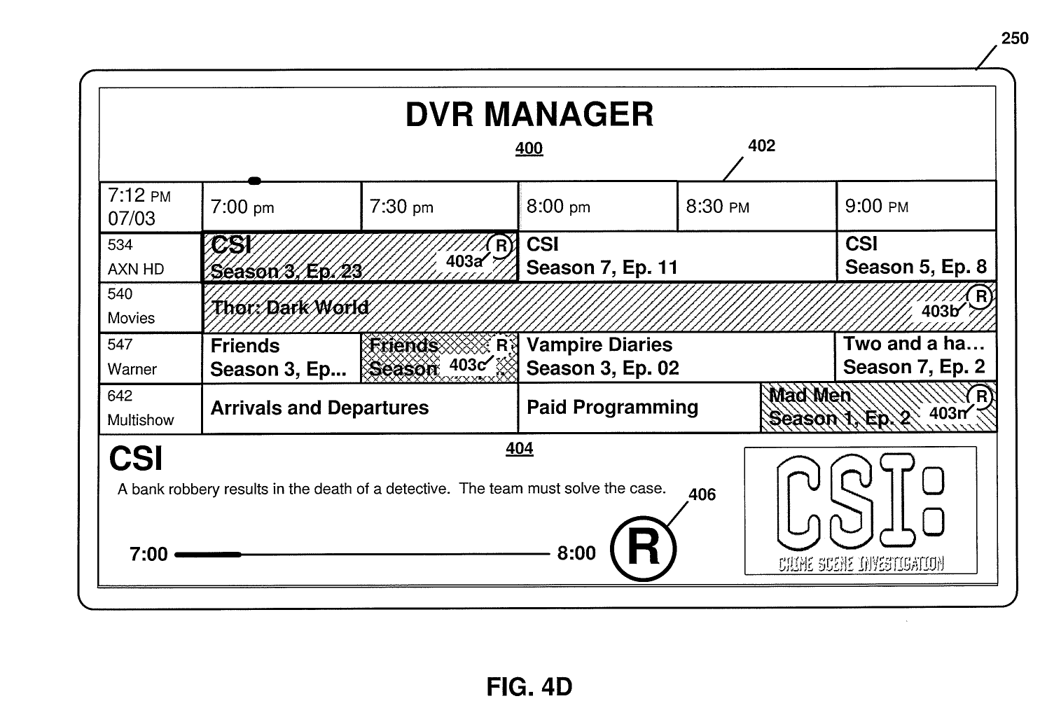

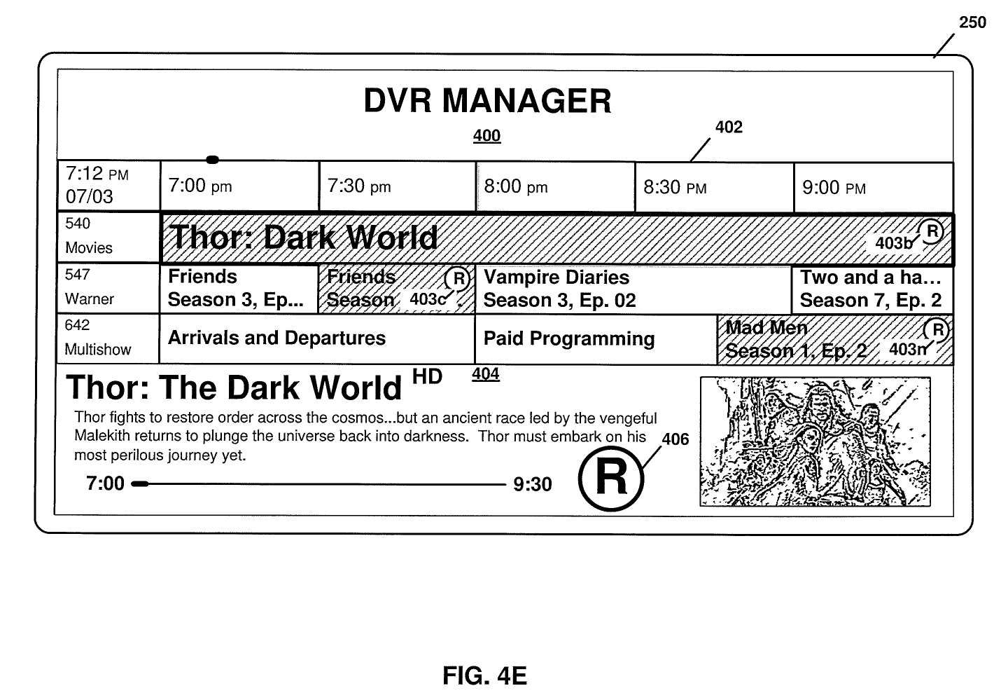

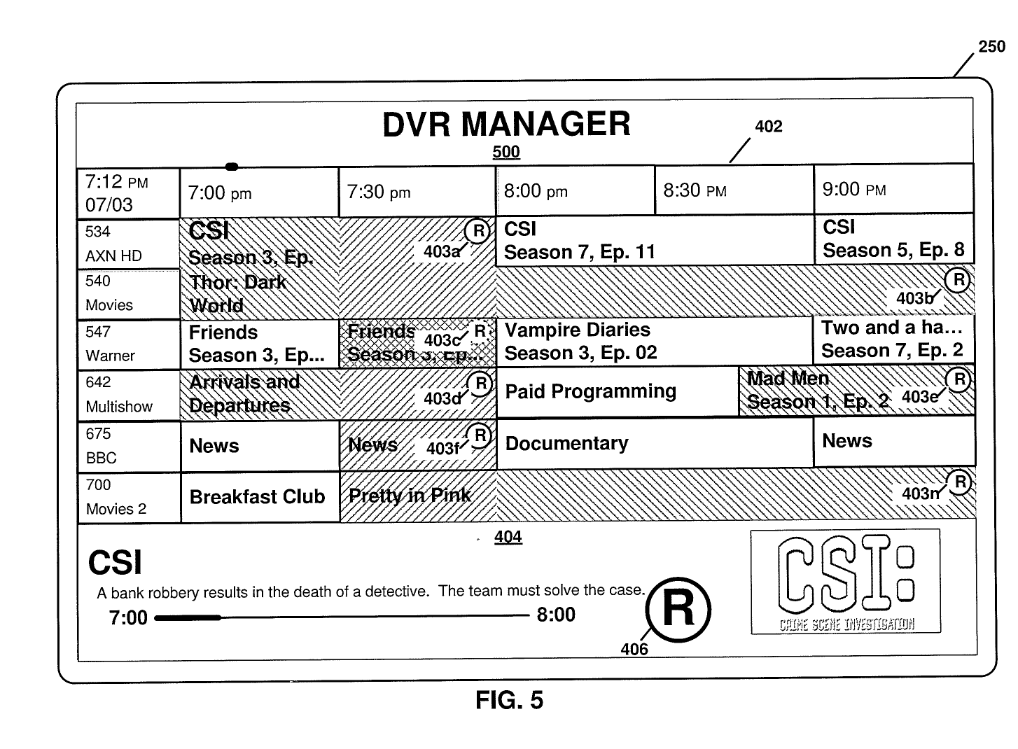

Record button 326 may enable a user to cause an item of multimedia content to be stored to a storage device. The functionality for recording via actuation of the record button is essentially conventional. However, activation of record button 326 also causes one or more interactive graphical user interfaces for scheduling recordings to be displayed automatically in order to provide a visual indication of the scheduled recordings alongside the other scheduled recordings. As described above, the number of multimedia programs that may be simultaneously recorded may be dependent on the number of available tuners or decoders. Thus, the graphical user interface that is displayed upon activation of record button 326 may depend on whether the recording of requested multimedia content would cause a conflict. However, this is not necessarily the case. It may be useful for the user to be aware of the committed load on the recording capability of the system (the scheduled recordings already set up) when a new recording is scheduled. Alternatively, if no conflict is present, activation of record button 326 may simply cause a confirmation message to be displayed (e.g., “Friends will be recorded”). However, if a conflict is present, one or more of the interactive graphical user interfaces that enable a user to resolve the conflict may be displayed. For example, one or more of the graphical user interfaces described below with respect to FIGS. 4A-5 may be displayed. In addition to one or more of the graphical user interfaces described below with respect to FIGS. 4A-5 being displayed upon a detected conflict, activation of DVR manager button 327 may cause one or more of graphical user interfaces described below with respect to FIGS. 4A-6 to be displayed to provide the user with the same information on scheduled recordings at any time. In this manner, a user may activate DVR manager button 327 to determine the likelihood of a conflict based on what has already been scheduled to be recorded. For example, activation of DVR manager button 327 may cause the graphical user interface illustrated in FIG. 4E to be displayed. As described in detail below, in the interactive graphical user interface illustrated in FIG. 4E no recording conflicts are present, but scheduled recordings are displayed.

As described above, devices with digital media playback capabilities, including, for example, televisions, set top boxes, and mobile devices, may be configured to provide users thereof with graphical user interfaces that enable the selection of content for viewing and/or recording. Navigational controls 340 may be configured to enable a user to navigate graphical user interfaces and select content using a graphical user interface. In one example, navigational controls 340 may be configured to enable a user to navigate graphical user interfaces and select content using one of more of the example graphical user interfaces described below with respect to FIGS. 4A-6.

In the example illustrated in FIG. 3, navigational controls 340 include navigational arrow buttons 341, select button 342, information button 343, menu button 344, guide button 345, back button 346, and exit button 347. Navigational arrow buttons 341 may be configured to move the position of a cursor associated with a graphical user interface and/or change the selection of an item included in an interactivegraphical user interface. For example, navigational arrow buttons 341 may enable the user to change the selection of a cell in a graphical user interface as described below with respect to FIG. 4A-4E.

Select button 342 may enable a user to further select an item of content and/or toggle a control associated with an item of content. As described in detail below, in one example, activation of select button 342 may cause the recording of a program scheduled to be recorded to be cancelled, either partially or entirely. Information button 343 may be configured to cause additional information associated with an item of content to be displayed. Menu button 344, guide button 345, back button 346, and exit button 347 may be configured to enable a user to cause different graphical user interfaces to be presented. Upon activation, menu button 344 may cause a graphical user interface including a high level menu to be displayed. In one example, a high level menu may include a menu that enables a user to change settings associated with the operation of a computing device. For example, a menu that enables a user to change which of a plurality of graphical user interfaces are presented when a recording conflict occurs. Upon activation, guide button 345 may be configured to provide a graphical user interface that enables a user to select content for viewing and/or recording. For example, activation of guide button 345 may cause a graphical user interface including available television content and associated schedule information to be displayed (e.g., a so-called grid guide). In one example, a user may select an item of content from within a grid and activate record button 326 in order to cause an item of content to be scheduled to be recorded. Back button 346 may be configured to enable a user to return to a previously displayed graphical user interface. Exit button 347 may be configured to enable a user to exit a graphical user interface.

Referring again to FIG. 2, computing device 200 is configured to send and receive data via a television network, such as, for example, television network 106 described above and send and receive data via a public network, such as, for example, public network 108. As described above, a communications network may be described based on a model including layers that define communication properties, such as, for example, physical signaling, addressing, channel access control, packet properties, and data processing in a communications system. In the example illustrated in FIG. 2, modem 212, tuners 213, transport module 214, and AV demux 216 may be configured to perform lower layer processing associated with television network 106 and network interface 218 may be configured to perform lower layer processing associated with public network 108.

In one example, modem 212 and tuners 213 may be configured to perform physical signaling, addressing, and channel access control according to the physical and MAC layers utilized in a television provider network, such as, for example, television provider network 106. In one example, modem 212 may be configured to receive signals from a coaxial cable and/or an over the air signal and perform low level signal processing (e.g., demodulation). As described above tuners 213 may be configured to tune to an analog channel and extract digital content from an analog channel. For example, tuners 213 may be configured to tune to a 6 MHz channel and extract one of four multiplexed digital channels from the 6 MHz channel. Tuners 213 may include ATSC and/or DVB tuners. In one example, tuners 213 may include two tuners. In another example, tuners 213 may include three to six or more tuners. It should be noted that although in the examples below the techniques are described with respect to two tuners and five tuners, the techniques described herein may be generally applicable to a computing device having any number of tuners.

In one example, modem 212 and tuners 213 may be configured to extract transport streams from signals received from a coaxial cable. In one example, a transport stream may be based on a transport stream defined by the Moving Pictures Experts Group (MPEG). In one example, a transport stream may include a plurality of program streams where each program stream respectively corresponds to a program available from a television network. Further, a transport stream may include a plurality of data streams (e.g., Program Map Table and EPG data). Transport module 214 may be configured to receive data from modem 212 and process received data. For example, transport module 214 may be configured to receive a transport stream including a plurality of program streams and extract individual program streams from a received transport stream. In one example, a program stream may include a video stream, an audio stream, and a data stream. AV demux 216 may be configured to receive data from transport module 214 and process received data. For example, AV demux 216 may be configured to receive a program stream from transport module 214 and extract audio packets, video packets, and data packets. That is, AV demux 216 may apply de-multiplexing techniques to separate video streams, audio streams, and data streams from a program stream. In one example, AV demux 216 may be configured to decapsulate packetized elementary video and audio streams from a transport stream defined according to MPEG-2 Part 1. It should be noted that although modem 212, tuners 213, transport module 214, and AV demux 216 are illustrated as having distinct functional blocks, the functions performed by modem 212, tuners 213, transport module 214, and AV demux 216 may be highly integrated and realized using any combination of hardware, firmware and/or software implementations.

Network interface 218 may be configured to enable computing device 200 to send and receive data via a public network. As described above, data sent or received via a public network may include data associated digital content, such as, for webpages enabling remote recording functionality. Network interface 218 may include a network interface card, such as an Ethernet card, an optical transceiver, a radio frequency transceiver, or any other type of device configured to send and receive information. Network interface 218 may be configured to perform physical signaling, addressing, and channel access control according to the physical and MAC layers utilized in a public network, such as for example, public network 108. Further, in a manner similar to that described above with respect to transport module 214 and A/V demux 216, network interface 218 may be configured to extract audio packets, video packets, and data packets from a data stream. For example, network interface 218 may be configured to extract video packets, audio packets, and data packets according to one or more of internet protocol (IP), transport control protocol (TCP), real time streaming protocol (RTSP), user datagram protocol (UDP), real time protocol (RTP), MPEG transport stream protocols, and IPTV protocols. It should be noted, that the techniques described herein are generally applicable to any and all methods of digital content distribution and are not limited to particular communications network implementations. For example, the techniques described herein may be applicable to digital content originating from one or more of a broadcast, a multicast, a unicast, an over-the-top content source, and a peer-to-peer content source.

Referring again to FIG. 2, data associated with digital content, such as, for example, music, videos, images, webpages, messages, voice communications, and applications may be stored in a computer readable medium, such as, for example, system memory 204 and storage devices 220. Data stored in a memory device may be retrieved and processed by CPU(s) 202, audio decoder 224, audio processor 226, video decoder 228, graphics processing unit 230, and display processor 232. As described above, CPU(s) 202 may be capable of retrieving and processing instructions, code, and/or data structures for implementing one or more of the techniques described herein. Each of audio decoder 224, audio processor 226, video decoder 228, graphics processing unit 230, and display processor 232 may also be capable of retrieving and processing instructions, code, and/or data structures for implementing one or more of the techniques described herein.

Audio decoder 224 may be configured to retrieve and process coded audio data. For example, audio decoder 224 may be a combination of hardware and software used to implement aspects of audio codec. Audio data may be coded using multi-channel formats such as those developed by Dolby and Digital Theater Systems. Audio data may be coded using a compressed or uncompressed format. Examples of compressed audio formats include MPEG-1, 2 Audio Layers II and III, AC-3, AAC, and Ogg Vorbis. Audio processor 226 may be configured to retrieve captured audio samples and may process audio data for output to an audio system (not shown). In some examples, audio processor 226 may include a digital to analog converter. An audio system may comprise any of a variety of audio output devices such as headphones, a single-speaker system, a multi-speaker system, or a surround sound system.

Video decoder 228 may be configured to retrieve and process coded video data. For example, video decoder 228 may be a combination of hardware and software used to implement aspects of video codec. In one example, video decoder 228 may be configured to decode video data encode according to any number of video compression standards, such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8, and High-Efficiency Video Coding (HEVC).

As described above, a device with media playback capabilities may provide an interactive graphical user interface that enables a user to schedule the recording of content. An interactive graphical user interface may include images and graphics displayed in conjunction with video content (e.g., playback icons overlaid on a video). Graphics processing unit 230 is an example of a dedicated processing unit that may be configured to generate interactive graphical user interfaces, including the graphical user interfaces described herein. That is, graphics processing unit 230 may be configured to receive commands and content data and output pixel data. Graphic processing unit 230 may operate according to a graphics pipeline process (e.g., input assembler, vertex shader, geometry shader, rasterizer, pixel shader, and output merger). Graphics processing unit 230 may include multiple processing cores and may be configured to operate according to OpenGL (Open Graphic Library, managed by the Khronos Group) and/or Direct3D (managed by Microsoft, Inc.).

Display processor 232 may be configured to retrieve and process pixel data for display. For example, display processor 232 may receive pixel data from video decoder 228 and/or graphics processing unit 230 and output data for display. Display processor 232 may be coupled to a display, such as display 250 (not shown in FIG. 1) using a standardized communication protocol (e.g., HDMI, DVI, DisplayPort, component video, composite video, and/or VGA). Display 250 may comprise one of a variety of display devices such as a liquid crystal display (LCD), a plasma display, an organic light emitting diode (OLED) display, or another type of display device capable of presenting video data to a user. Display 250 may include a standard definition television, a high definition television or an ultra-resolution display. Further, display 250 may include an integrated display of a portable computing device (e.g., a mobile phone, a laptop, a personal data assistant (PDA), or a tablet device). As described above, in some examples a portable computing device may operate as an I/O device for a stationary computing device.

As described above, traditional digital video recording devices may be less than ideal for enabling a user to resolve recording conflicts. As described in detail below, each of the graphical user interfaces illustrated in FIGS. 4A-5 may enable a user to avoid and/or resolve recording conflicts. As described above, recording conflicts may be due to insufficient tuner or decoding resources (herein “receiver resources”). It should be noted, however, that in other examples recording conflicts may be due other causes. For example, a service provider may artificially limit the number of simultaneous recordings or the available storage device(s) may not support the number of overlapping recordings scheduled.

As illustrated in FIGS. 4A-4E, graphical user interface 400 includes a listing of television channels including programming and associated time slots 402, recording indicators associated with items of content 403a-403n, informational pane 404, and recording status icon 406. In the example illustrated in FIGS. 4A-4E, the interactive graphical user interface illustrated in FIG. 4A may be presented automatically to a user upon a recording conflict being detected. The conflict is detected by the software running the interactive graphical user interface logging the scheduled recordings and the capability of receiver resources and/or storage devices. For example, graphical user interface 400 may be presented upon a user selecting an item of content for recording from an electronic programming guide. In the example illustrated in FIGS. 4A-4E, a conflict occurs when a user attempts to record three programs simultaneously (e.g., a device has two tuners). In the example illustrated in FIGS. 4A-4E, the graphical user interface illustrated in FIG. 4A is presented to a user when a user attempts to record Friends, but has previously scheduled CSI and Thor for recording. It should be noted that in some cases a scheduled recording may be due a user selecting to automatically record episodes of a television program (e.g., setting automatic recording of all new episodes of a television series). Further, in the example illustrated in FIG. 4A, a user has previously scheduled Mad Men to be recorded. However, the scheduled recording of Mad Men does not cause a conflict. Thus, graphical user interface 400 is configured to display channels having scheduled recordings with respect to a common timeline. It should be noted that in one example, channels having scheduled recording without conflicts may be omitted from graphical user interface 400. For example, in one example, channel 642 may be omitted, as the scheduled recording of Man Men does not cause a conflict. Thus, graphical user interface 400 may be configured to display a subset of channels available through a service provider where the subset of channels includes channels associated with a recording conflict. It should be noted that in the example where there are more channels than can be displayed on a display, graphical user interface 400 may be configured to enable a user to scroll through channel listings associated with scheduled recordings.

As illustrated in FIG. 4A each of the previously scheduled recordings and the potential recordings are respectively highlighted as indicated with hatching and cross-hatching (representing different colours) in FIGS. 4A-4E. Each type of highlighting may be respectively associated with a current recording status. In the example illustrated in FIGS. 4A-4E there may be four types of recording statuses: not scheduled to record (no hatching), scheduled to record, no conflicts (downward hatching), scheduled to record, conflict (upward hatching), and potential recording conflicted (cross-hatching). It should be noted that each of these statuses may be associated with color highlights in an actual implementation. For example, not scheduled to record (no highlight), schedule to record, no conflicts (green highlight), scheduled to record, conflict (orange highlight), and potential recording conflicted (red highlight). As further illustrated in FIGS. 4A-4E each item of content associated with a scheduled recording or a potential scheduled recording includes respective recording indicators 403a-403n. Where the outline of a recording indicator (or color of a recording indicator in an implementation) indicates a recording status. In the example illustrated in FIGS. 4A-4E, a solid outline indicates that a program is scheduled for recording and a dashed outline indicates a potential recording. Thus, upon being presented channel listing 402, a user may quickly discern the sources of recording conflicts, including the temporal relationship of programs causing a conflict and potential resolutions. As described above, in one example, a channel having a scheduled recording that does not cause a conflict may be omitted from graphical user interface 400. Thus, interactive graphical user interface 400 may efficiently present a user with information about, and the means to resolve, a recording conflict.

As further illustrated in FIG. 4A, a program with channel listing may be highlighted (Thor in FIGS. 4A-4C and 4E, and CSI in FIG. 4D). In one example, a user may change which program is highlighted by using navigational arrow buttons 341. In one example, a user may only be able to select programs associated with a conflict to be resolved. For example, CSI, Thor, and Friends in the example illustrated in FIG. 4A. In this manner, navigation may be simplified in order to enable a user to resolve a conflict more efficiently. For example, when the graphical user interface illustrated in FIG. 4A is presented to a user, a user may activate an up navigation key 341 which may cause CSI to become selected and cause the graphical user interface illustrated in FIG. 4D to be displayed. As illustrated in each of FIGS. 4A-4E, when a particular item of content is selected informational pane 404 includes information associated with the selected item of content. Informational pane 404 may include recording status icon 406 which may indicate a recording status. In the example illustrated in FIGS. 4A-4E, recording statuses associated with recording status icon 406 may include recording scheduled (solid line, illustrated in FIG. 4A), schedule recording cancelled (dotted line, illustrated in FIG. 4B), and partial recording (incomplete circle, illustrated in FIG. 4C). In one example, a recording status may change as a user activates a command (e.g., select button 342 or record button 326) while an item of content is selected. For example, when the graphical user interface illustrated in FIG. 4A is presented to a user, a user may activate select button 342 which may cause the recording of Thor to be cancelled in its entirety. This may cause Friends to be scheduled to be recorded and the graphical user interface illustrated in FIG. 4B to be presented. As illustrated in FIG. 4B, the respective highlighting and recording indicators 403b and 403c change with respect to FIG. 4A to indicate the updated recording status. As described above, a recording status may include a partial recording. For example, when the graphical user interface illustrated in FIG. 4B is presented to a user, a user may subsequently activate select button 342 which may cause the recording of Thor to be partially cancelled, i.e., only cancelled as necessary to resolve a conflict. This may cause Friends to be scheduled to be recorded and the graphical user interface illustrated in FIG. 4C to be presented. Partial recording may be useful when a user has viewed portions of a particular item of content or does not wish to view a segment of an item of content. For example, a user may have previously viewed the first half of a movie and may only wish to record the second half of a movie. Further, a user may wish to record programming during halftime of a sporting event.

As described above, DVR manager button 327 may enable a user to determine the likelihood of a conflict based on what has already been scheduled to be recorded. In the example illustrated in FIGS. 4A-4E, a user may cancel the recording of CSI to resolve the conflict presented by attempting to record Friends. A user may then exit graphical user interface 400 to search for other programs to record (e.g., by activating exit button 347). A user may wish to recall currently scheduled recordings in order to visually confirm the currently scheduled recordings and/or determine if a future recording (e.g., a recording starting at 9:00 PM) is likely to cause a conflict. In this example, a user may activate DVR manager button 327 which may cause the graphical user interface illustrated in FIG. 4E to be presented. Based on the graphical user interface illustrated in FIG. 4E a user may determine that recording a program at 9:00 PM will cause a conflict to be generated. In this manner, the graphical user interfaces illustrated in FIGS. 4A-4E may enable a user to determine actual and potential conflicts and respectively resolve or avoid recording conflicts.

As described above, in one example, a digital video recording device may include five tuners. In this case, a conflict may occur when a user has scheduled five programs for recording and attempts to simultaneously record a sixth program. FIG. 5 illustrates an example of a graphical user interface that may enable a user to resolve conflicts associated with a digital video recording device allowing five simultaneous recordings. As illustrated in FIG. 5, graphical user interface 500 includes a listing of television channels including programming and associated time slots 402, recording indicators associated with items of content 403a-403n, informational pane 404, and recording status icon 406 as described above with respect to FIG. 4A-4E. As illustrated in FIG. 5, programs CSI, Thor, Friends, Arrivals and Departures, News, and Pretty in Pink may be associated with a conflict due to a user attempting to schedule a recording of Friends. As illustrated in FIG. 5, only portions of each program with may be associated a conflict. Thus, different segments on programs may be highlighted accordingly. A user may resolve recording conflicts using graphical user interface 500 in a manner to that described above with respect to graphical user interface 500. For example, a user may to choose to partially cancel the recording of one or more programs. By respectively highlighting segments of a program based on recording statuses, graphical user interface 500 may enable a user to efficiently resolve recording conflicts. It should be noted that although graphical user interfaces 400 and 500 are based on half hour time slots, in other examples shorter time slots may be used. For example, 15 minute time slots. In this manner, even more partial recording options may be available for a user to resolve recording conflicts.

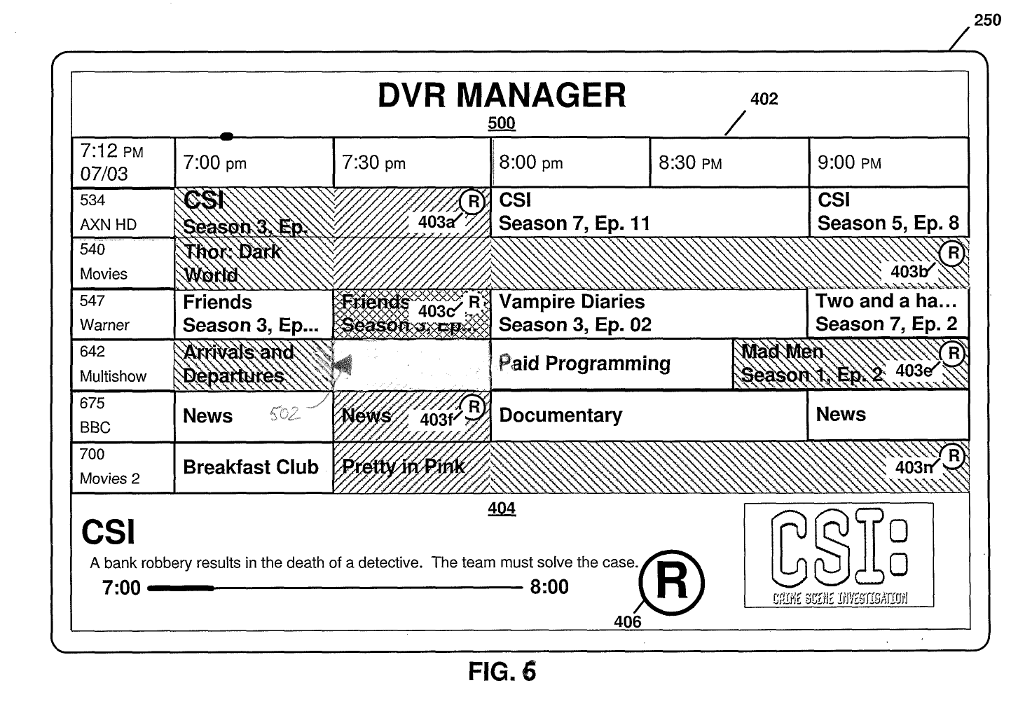

In the mode in which only programs associated with a conflict can be navigated between, the left/right navigation buttons 341 have a different purpose to that described above. Instead of enabling the highlighting to move left/right between programs on the same channel or other service offering, they control the proportion of a program that is scheduled for recording. A cursor initially at the start or end of the highlighted program in conflict appears when the left or right navigation button is activated and can be moved to right or left to change the point in the program at which recording of the program in conflict is started or stopped. In this way the user can resolve the conflict by eliminating only part of a program from being recorded. For example, it may be that a news program is part of a recording conflict but the user is only interested in recording the headlines. He/she can navigate the cursor using the left button 341 to eliminate from recording the end of the news program if that is the part in conflict. This is illustrated in FIG. 6 in which the left navigation button 341 has been actuated in the DVR Manager screen. This has caused the cursor 502 to move to the left and provide a visual indication of the reduction in recording time for the program Arrivals and Departures, truncating the recording at 7:00 pm and not 8:00 pm. Upon the user actuating the Select button 342, the screen will clear the indication of conflict as the user action has resolved it. In an alternative form, the controller 300 has a dedicated Edit button that can be used to enable the left/right navigation buttons to enable movement of the cursor 502 through a highlighted scheduled event as above.

It should be noted that a computing device may display any and all combinations of the graphical user interfaces illustrated in FIGS. 4A-5 and the example descriptions of how graphical user interfaces may be presented to a user are for illustrative purposes. In this manner, computing device 200 represents an example of a device configured enable a user to resolve recording conflicts.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of enabling a user of a device having recording capabilities to resolve recording conflicts, the method comprising:
presenting on a display an interactive graphical user interface including a navigable listing of events receivable by the device, wherein the listing includes one or more service offerings including previously scheduled recordings of events and a service offering including a potential scheduled recording;
receiving a first user input to select a listing of an event for recording wherein the potential scheduled recording causes a recording conflict such that the device is unable to perform all the scheduled recordings;
displaying another interactive graphical user interface including a navigable listing of the conflicting scheduled recordings;
receiving a second user input signal to select one of the events associated with the recording conflict; and
receiving a third user input signal to change a recording status of the selected event to resolve the recording conflict.

2. The method of claim 1, wherein the other listing includes service offerings associated with the recording conflict.

3. The method of claim 1, wherein receiving a second user input signal includes enabling a user to use navigational controls limited to selecting events associated with the recording conflict.

4. The method of claim 1, wherein the other interactive graphical user interface is presented on the display automatically when the potential scheduled recording causes the recording conflict.

5. The method of claim 1, wherein receiving a third user input signal includes enabling a user to cancel a scheduled recording either partially or completely.

6. The method of claim 5 wherein receiving the third user input signal enables the user to change the recording status of the selected event by editing the displayed schedule for the selected event to start or stop the event being recorded at a point between the scheduled start and stop times for the event.

7. The method of claim 1, wherein the event includes a transmitted video receivable by the device.

8. A device having recording capabilities, the device comprising one or more processors configured to:
present on a display an interactive graphical user interface including a navigable listing of scheduled events receivable by the device, wherein the listing includes service offerings including previously scheduled recordings of events and a service offering including a potential scheduled recording;
enable a user to select a listing of an event for recording wherein the potential scheduled recording causes a recording conflict such that the device is unable to perform all the scheduled recordings;
present on a display, another interactive graphical user interface including a navigable listing of the conflicting scheduled recordings;
enable a user to select an event associated with the recording conflict; and
enable a user to change a recording status of the selected event to resolve the recording conflict.

9. The device of claim 8, wherein the listing includes service offerings associated with the recording conflict.

10. The device of claim 8, wherein to enable a user to select an event associated with the recording conflict includes enabling a user to navigate to events associated with the recording conflict.

11. The device of claim 8, wherein to enable a user to change a recording status of the selected event associated with the recording conflict includes enabling a user to cancel a selected scheduled recording either partially or completely.

12. The device of claim 11, wherein the user is enabled to change the recording status of the selected event by editing the displayed schedule for the recording to start or stop the event being recorded at a point between the scheduled start and stop times for the event.

13. The device of claim 8, wherein the interactive graphical user interface is presented on the display automatically when the potential scheduled recording causes the recording conflict.

14. The device of any of claims 8, wherein the event includes a transmitted video receivable by the device.

15. (canceled)

16. A non-transitory computer readable medium, comprising instructions that when execute by a processor, the instructions to:
present on a display an interactive graphical user interface including a navigable listing of scheduled events receivable by the device, wherein the listing includes service offerings including previously scheduled recordings of events and a service offering including a potential scheduled recording;
enable a user to select a listing of an event for recording wherein the potential scheduled recording causes a recording conflict such that the device is unable to perform all the scheduled recordings;
present, on a display, another interactive graphical user interface including a navigable listing of the conflicting scheduled recordings;
enable a user to select an event associated with the recording conflict; and
enable a user to change a recording status of the selected event to resolve the recording conflict.

17. The non-transitory computer readable medium of claim 16, wherein the listing includes service offerings associated with the recording conflict.

18. The non-transitory computer readable medium of claim 16, wherein to enable a user to select an event associated with the recording conflict includes enabling a user to navigate to events associated with the recording conflict.

19. The non-transitory computer readable medium of claim 16, wherein to enable a user to change a recording status of the selected event associated with the recording conflict includes enabling a user to cancel a selected scheduled recording either partially or completely.

20. The non-transitory computer readable medium of claim 16, wherein the user is enabled to change the recording status of the selected event by editing the displayed schedule for the recording to start or stop the event being recorded at a point between the scheduled start and stop times for the event.

21. The non-transitory computer readable medium of claim 16, wherein the interactive graphical user interface is presented on the display automatically when the potential scheduled recording causes the recording conflict.
